(19) United States
(12) Patent Application Publication
(10) Pub. No.: US 2011/0234720 A1
(43) Pub. Date: Sep. 29, 2011

(54) Multi-Part Form Made Using Single Pass/Single Web Manufacturing Process

(75) Inventors: F. Paul Valenti, JR., Barrington, IL (US); Carl Opel, Carol Stream, IL (US); Dan Hedger, Grayslake, IL (US)

(73) Assignee: CHICAGO TAG & LABEL, Libertyville, IL (US)

(21) Appl. No.: 12/730,320

(22) Filed: Mar. 24, 2010

(51) Int. Cl. B41J 2/01

(52) U.S. Cl. 347/101

(57) ABSTRACT

A method is disclosed for manufacturing a multi-part form (MPF) in a single pass process wherein at least some of plurality of parts of the MPF may include variable data such as a serial number, tracking number or barcode. One disclosed method may include passing a single web through a plurality of print-heads wherein each of the plurality of print-heads prints a top or bottom side of a different part of the MPF on a different portion of the web. The copy printed on the parts by the plurality of print-heads may include indicia for the sequence of parts of the MPF. The web may then be passed through a digital printer for the printing of variable data on at least some of the parts. The method may further include passing the web through at least one additional print-head for printing a CF coating on the top surface of one or more parts. The printing of the CF coating on the top surface of the one or more parts preferably does not overlap any variable data.

### BACKGROUND

1. Technical Field

This disclosure relates to the manufacture of multi-part or multi-page forms fabricated from a single web in a single pass process. The disclosed forms and methods of manufacture thereof, include carbonless, pressure sensitive forms, with variable imaging, with identifying indicia such as serial numbers, tracking numbers or barcodes on one or more of the parts. An integrated label on at least one part of the form may also be provided.

2. Description of the Related Art

Multi-part forms are conventionally manufactured by first printing each part on a first continuous web on a separate press run while simultaneously punching registration line-holes along the outer margins of the web. Each part or page of the form is printed on a separate web. The rolled webs of the separate parts are then loaded onto separate unwind shafts of a collating machine, which unwinds each rolled web into a web path in which each web from each roll is glued in order on top of or below each other to create the multi-part form. The webs are driven and held in registration to each other by pin-feeds on the collating machine that penetrate the registration line-holes.

Conventional methods of collating forms from multiple webs is susceptible to registration errors from one part to the next due to possible variations in registration during the printing of each separate part and varying amounts of paper stretch amongst the webs. Further, conventional methods of collating forms requires extra paper for margins disposed on either side for the registration line-holes, which gets trimmed off at the end of the process as waste. Also, conventional collating equipment typically requires excessive amounts down time because several rolls of paper must be mounted onto the collator and changed every time the rolls run out of paper.

Further, when serial numbers or barcodes are printed on multi-part forms, errors can occur such as mismatching the number from one part of the form to the other parts of the form if the collator operator misaligns the parts or if there is an error in printing of the numbers or barcodes during one of the multiple press runs. As a result, the process of aligning the numbers from each web may be time-consuming and therefore costly and mistakes can create substantial quantities of waste product.

Accordingly, there is a need for improved processes for printing multi-part or multi-sheet forms or booklets. The development of a single pass process using a single web would address some of the registration issues experienced using prior art techniques, although no single pass processes are currently available for multi-part or multi-page forms. Further, in today's competitive economy, even though the margins for the tractor feed or registration pin-hole portion of a web can be trimmed and recycled, the margins still represent waste and additional costs. Also, the use of multiple webs results in down time for roll changes. Automated splicing technology is unavailable for multi-part forms using multiple webs because automated splicers require tension and are incompatible with collators which must operate without tension. Finally, automated splicers also can create inaccurate registrations for the different webs.

As a result, there is a need for improved manufacturing methods and a manufacturing system for multi-part forms.

### SUMMARY OF THE DISCLOSURE

A single pass, single web method for fabricating multi-page or multi-part forms, such as integrated forms or booklets, is disclosed that provides excellent registration of each part because each part may be printed in order and during the same revolution of the printing cylinder.

The disclosed methods require no additional margins used for tractor feed or registration pin-holes as the single web is fed through the press by the pull tension of the rotary printing press. The disclosed methods also enable a multi-part form to be printed using a single print-head.

An automated butt splicer may be provided that facilitates splicing one roll of paper to the next roll without downtime. This is possible because the disclosed methods and systems do not require collating or a tension-free collating process.

The parts of the disclosed form may be printed in immediate sequence of each other, and the variable data (e.g., serial nos., tracking nos., barcodes, etc.) are also printed on the parts of the form in immediate sequence of each other. The parts are printed, including the numbers or variable data, cut to sheets, and glued together immediately at high speeds, thereby reducing the possibilities for sequencing errors. No human intervention is required to match up the numbers from one part to the other, thus reducing time inefficiencies, material waste, and the chance of human error related to matching of the numbers on all parts of a form.

In an embodiment, a method is disclosed for manufacturing a multi-part form wherein at least some of plurality of parts of the multi-part form includes variable data selected from the group consisting of a serial number, tracking number or barcode. One disclosed method may include passing a single web, which may have a bottom side pre-coated with encapsulated dye (CB coating), through a single print-head or optionally, a plurality of print-heads, wherein print-head prints a top or bottom side of a different part of the multi-part form on a different portion of the web.

In a refinement, a plurality of print-heads may be used for multiple colored print material on one or more of the parts. The material printed on the parts by the plurality of print-heads may include indicia in the form of language, color or form content. Variable data such as bar codes, serial numbers or tracking numbers are printed on each part as the web passes through a computerized inkjet printing station or other type of computer controlled printer. The method may further include passing the web through at least one additional print-head for printing dye-absorbing material on the top surface of one or more parts. Optionally, dye-absorbing material may be printed on the top surface of the one or more parts does not overlap any variable data printed on the top surface of the parts. As a result, the variable data (e.g., barcodes, tracking nos., serial nos.) are not marred during normal use of the form.

In a refinement, the multi-part form may include an ordered sequence of parts and the parts are printed on the web in the ordered sequence.

In another refinement, two multi-part forms are printed simultaneously on the web in a side-by-side fashion.

In another refinement, the parts are cut and adhesive is selectively applied to stub areas of the parts that are in matching registry with one another as the parts are stacked in order.

In another refinement, the parts of the form are stacked in a star-wheel stacker, where they are bonded together to become a completed multi-part form.

In a refinement, the parts are cut and adhesive is selectively applied to stub areas of the cut parts except a top part before the parts are stacked in order.

In a refinement, plurality of parts may include a cover sheet. In a further refinement, the cover sheet is printed on both sides. In another refinement, the cover sheet may be labeled with the variable data used for the remaining parts.

In another refinement, the printed web is passed through an integrated label/patch applicator for purposes of applying adhesive and a piece of release paper to the underside of the bottom part.

It will be noted that a four sheet or four-part form and methods of manufacture thereof are disclosed. However, the disclosed methods apply to multi-part forms with more or less than four parts, with more complicated color schemes and with labels disposed on any of the parts, as opposed to the bottom part as illustrated herein.

The disclosed methods may include the use of a web that is pre-coated with dye-absorbing material (a.k.a., CF coating or carbonless-front coating) on the front or top surface and/or pre-coated with encapsulated dye (a.k.a., CB coating or carbonless-back) on the back or bottom surface of the web. In contrast, the disclosed methods may include printing a CF coating the top surface and/or printing a CB coating on the bottom surface of the web.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 schematically illustrates a manufacturing system for carrying out the disclosed methods for forming multi-part forms with variable data on a plurality of the parts using a single web and a continuous process;

FIG. 2 is a top plan view of a portion of the web of one disclosed multi-part form prior to cutting illustrating two multi-part forms in a side-by-side fashion and illustrating the printing of dye-absorbing coating on top surfaces of two of the parts without interfering with the spaces reserved for variable data such as barcodes, tracking numbers or serial numbers;

FIG. 3 is a bottom plan view of the web portion illustrated in FIG. 2, particularly illustrating the bottom or back side of the top part or cover sheet;

FIG. 4 is a top plan view of the cover sheet illustrated in FIG. 2;

FIG. 5 is a plan view of the bottom side of the cover sheet and the top side of the second part of the multi-part form illustrated in FIGS. 2-4;

FIG. 6 is a plan view of the bottom side of the second part (which may be blank) and the top side of the third part of the multi-part form illustrated in FIGS. 2-5;

FIG. 7 is a plan view of the bottom side of the third part (which may be blank) and the top side of the fourth part of the multi-part form illustrated in FIGS. 2-6; and

FIG. 8 is a bottom plan view of the multi-part form illustrated in FIGS. 4-7, particularly illustrated the piece of release paper on the bottom side of the fourth part.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the four-page or four-part embodiments illustrated herein.

### DETAILED DESCRIPTION OF THE PRESENTLY PREFERRED EMBODIMENTS

In general, multi-part forms (MPFs) contain two or more pages per form, which will hereinafter be referred to as “parts.” Each part of the form may include at least one variable data in the form of a serial number, tracking number, machine-readable bar code and/or other type of human readable number, which serves to distinguish the form from other like forms and to identify each part of the form as they are separated during normal use. The variable data may also function as a tracking number for the form itself or for the item that the form or a part of the form is attached to or pertains to.

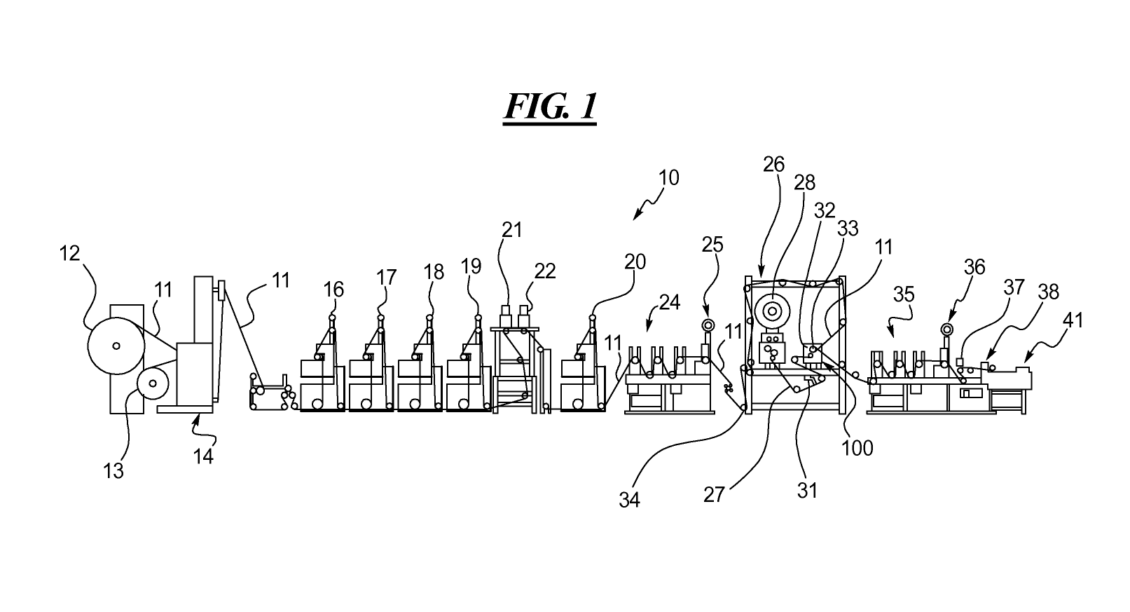

Previously, the manufacture of MPFs required multiple webs and multiple passes through a printing system. In contrast, MPFs manufactured in accordance with this disclosure may be fabricated, including binding the parts together along the stub, in single pass through the system 10 illustrated in FIG. 1. Specifically, the system 10 supports a web 11 in the form of a primary roll 12 and a backup roll 13. In the event the primary roll 12 reaches its end or tail, the web from the roll 13 is automatically spliced onto the moving web by the automated butt-splicer 14. To print the various images on the parts or pages of the MPF, the web 11 is passed a flexographic print-head, like those shown at 16-20 in FIG. 1. While five flexographic print-heads 16-20 are illustrated in FIG. 1, only a single print-head 16-20 is needed for a single-color MPF. The number can vary depending upon the number of colors of the MPF.

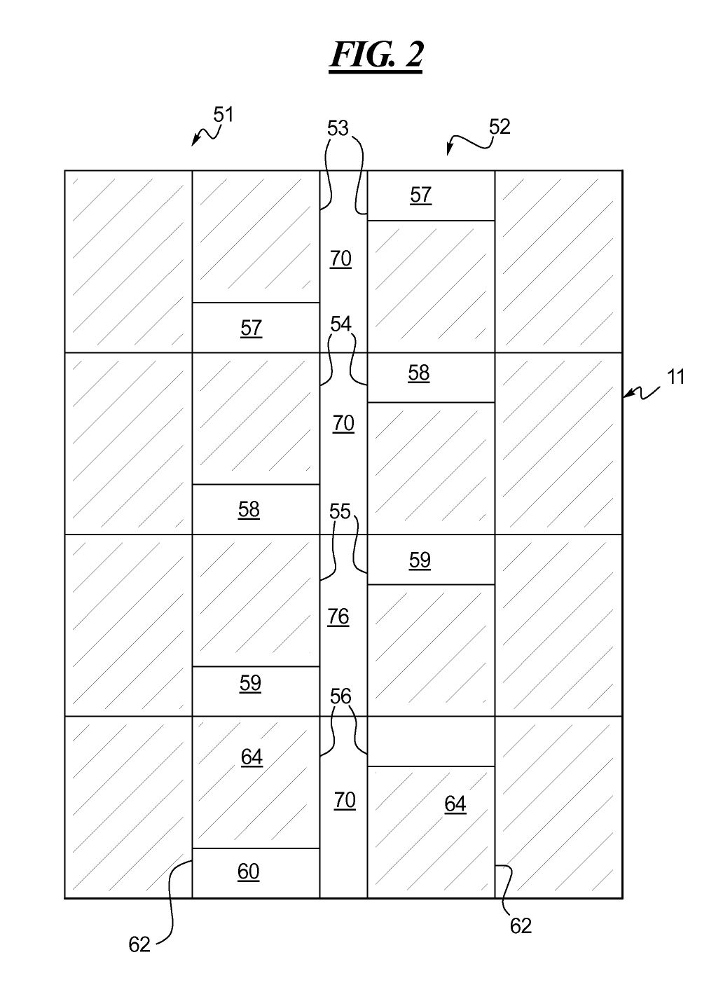

Flexographic print-heads are ideal for printing static copy and coatings on the various parts of the MPF. In contrast, one or more inkjet printers 21, 22 may be provided for printing variable data on the various parts of the form, such as serial numbers, tracking numbers, barcodes etc. Digital printers may be used in addition to or instead of the flexographic printers 16-19 and inkjet printers 21-22. The optional flexographic printer 20 may be used to apply a CF coating to selected portions of the top surfaces of the third and fourth parts 55, 56 is illustrated in FIG. 2. While only a single flexographic print-head 16 is needed for a single color MPF, the additional print-heads 17-19 may be used for multiple color MPFs.

After printing, the web 11 passes through a cutting station 24 where portions of the web may be perforated or die cut. Another advantage to the disclosed system 10 is that an adhesive layer may be applied to an underside of the web 11 at the integrated label/patch applicator station 26. A web of release paper 27 is drawn from the roll 28 and coated with adhesive using the hot melt adhesive applicator 31. The coated release paper web 27 may be cut to any desired length by the cutter 32 and joined to at the desired location on the underside of the web 11 at the vacuum cylinder 33.

After passing through the integrated label/patch applicator station 26, the web proceeds to the die cutting station 35 and trim/waste removal station 36. Adhesive is applied to the stub areas at 37. The adhesive applicator 37 is controlled so that only the upper surfaces of stub areas of the bottom parts or sheets are coated with adhesive and not the top part or cover sheet. The forms are sheeted at the sheeter station 38 and stacked at the star will stacker station 41.

FIG. 2 illustrates a section of printed web 11 wherein two forms 51, 52 are being manufactured on the web 11 in a side-by-side fashion. Each form 51, 52 may include a cover sheet 53. It will be noted that the cover sheet 53 of the form 51 on the left is upside down from the viewpoint of FIG. 2. Each form 51, 52 may also include a second sheet 54, a third sheet 55 and a bottom sheet 56. Unique identifying indicia in the form of barcodes, serial numbers, tracking numbers or other identifying indicia may be placed in the areas 57, 58, 59, 60 as shown in FIG. 2. Further, the upper surfaces of the third and fourth sheets 55, 56 are coated with a CF coating in all areas except 59, 60. The CF coating may be applied by any of the flexographic printers 16-20 (FIG. 1). In this manner, the transfer of information does not interfere with the reading of barcodes, serial numbers, tracking numbers, etc. In an embodiment, a perforation may be placed at 62 in the bottom sheets 56. In another embodiment, one or more areas such as those shown at 64 may be colored.

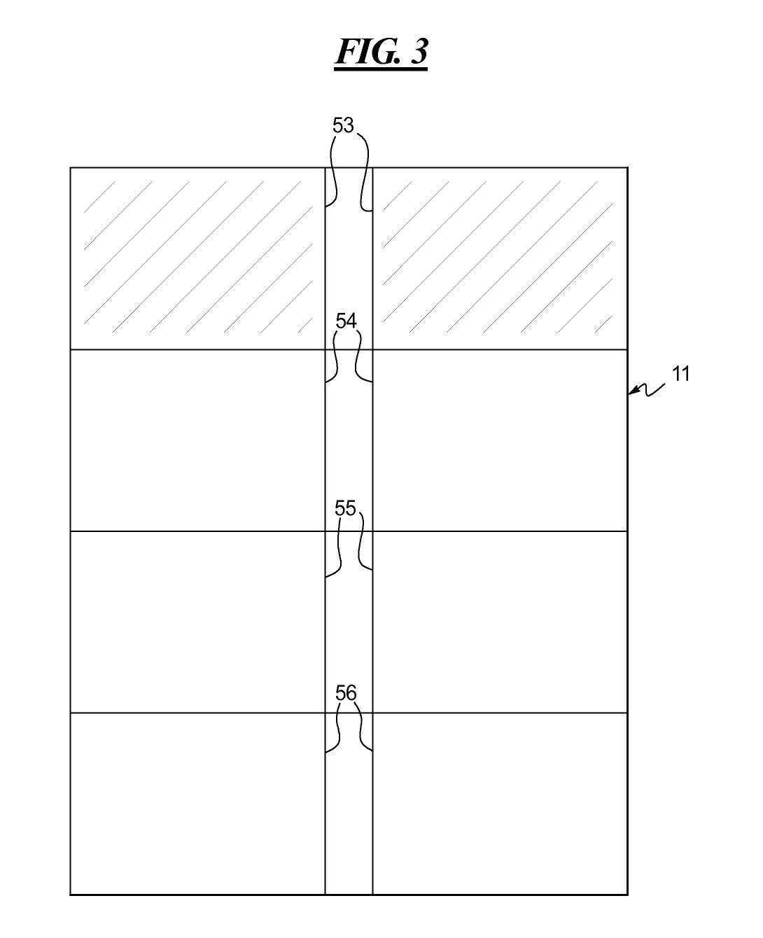

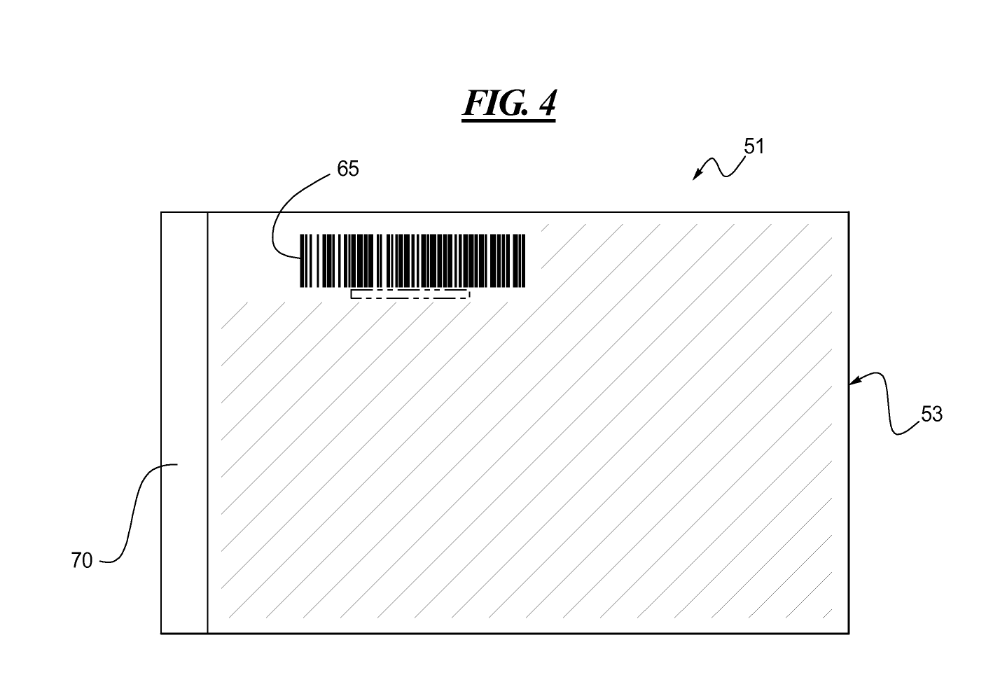

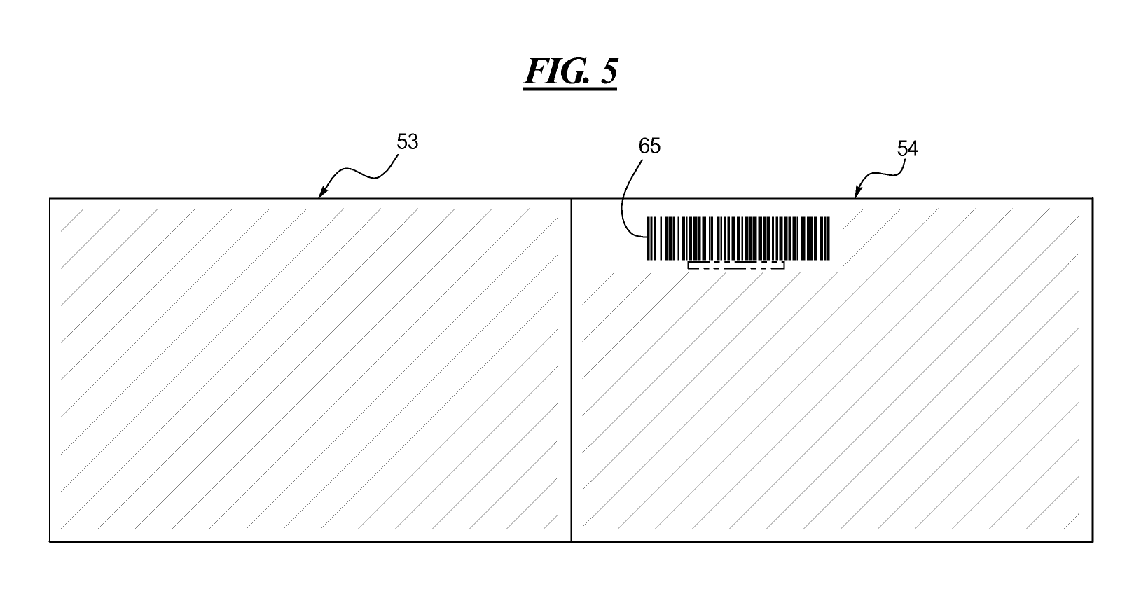

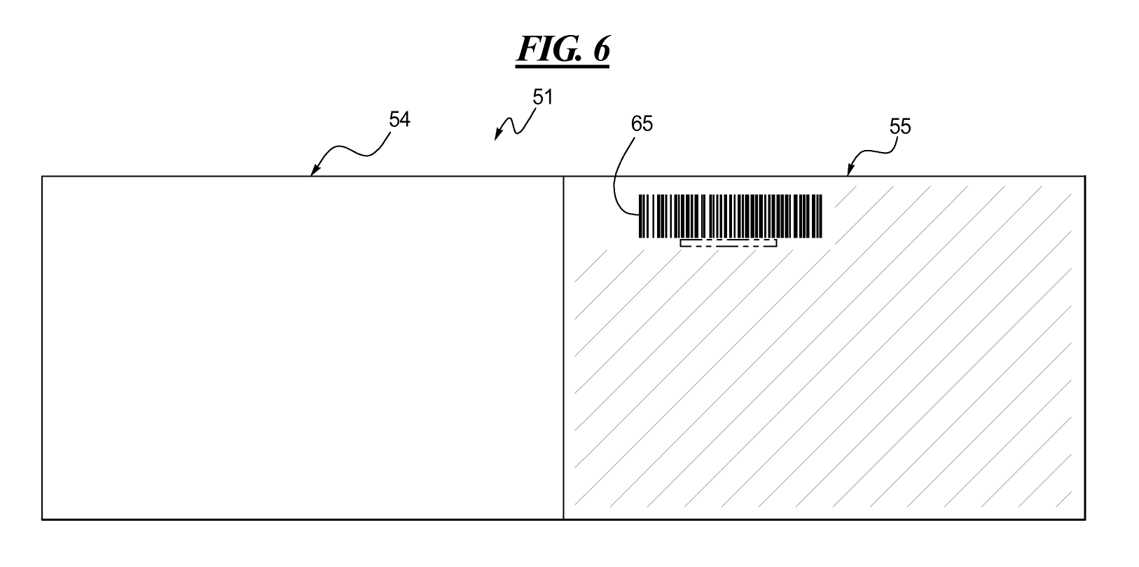

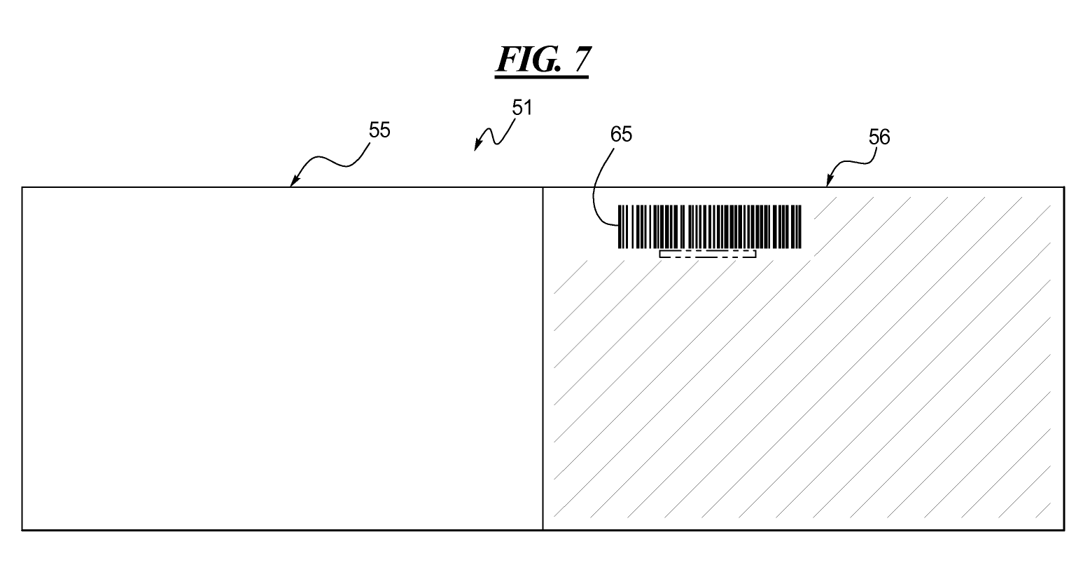

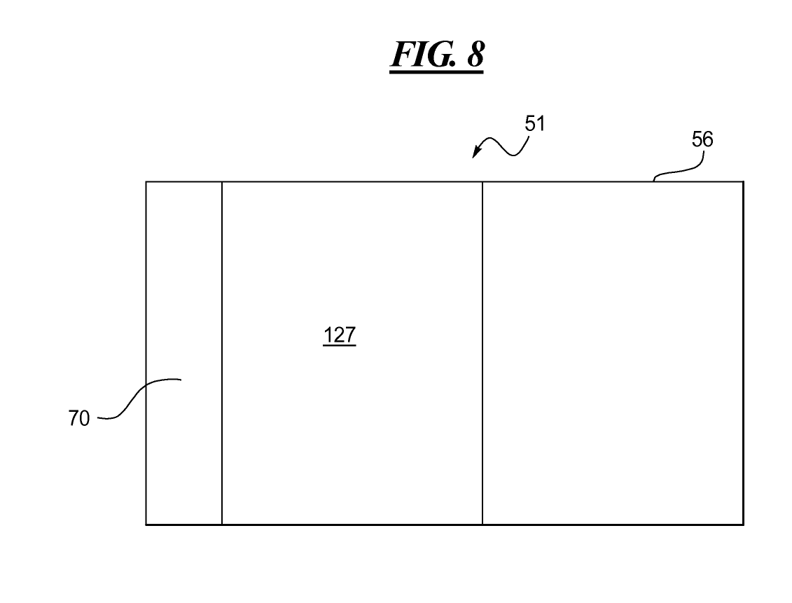

FIG. 3 illustrates the underside of the web 11, particularly illustrating the bottom sides of the cover sheets 53. FIG. 4 is a plan view of a cover sheet 53 with a barcode 65. FIG. 5 is a plan view of the backside of the cover sheet 53 and front side of the second sheet 54 and barcode 65. FIG. 6 is a plan view of the backside of the second sheet 54 (which is blank) and top side of the third sheet 55 and barcode 65. FIG. 7 is a plan view of the backside of the third sheet 55 (which is blank) and the topside of the fourth sheet 56 and barcode 65. FIG. 8 is a plan view of the bottom side of the completed form 51 illustrating the layer of adhesive and release paper 127 which is attached to the underside of the bottom sheet 56. FIGS. 4 and 8 also illustrate the edge or stub areas 70 which are connected by glue or adhesive. The upper surfaces of each stub 70, with the exception of the cover sheet 53 is coated with adhesive thereby creating the multi-page form or booklet 51.

In addition to using the multiple rotary flexographic print-heads 16-20, digital printing may be employed. The web 11 may include a CB coating or the CB coating may be applied by any of the print-heads 16-20. Paper may be purchased with or without a CB coating. The dye capsules of the CB coating burst when pressure from a pen is applied to the top side of the part 54-55. Then, selected portions of top surfaces of the bottom parts 55, 56 are coated with a CF coating by any of the printers 16-20 that absorbs the dye to create a copy of the image created by the dye of bottom side of the part above. Optionally, the CF coating is not applied to the areas 59, 60 so that interference with reading of barcodes or serial numbers is avoided.

Again, instead of purchasing CB-coated paper for the web 11, the CB coating can be applied in line using the one of the flexographic print-heads 16-20 as is performed with the CF coating for the parts 55, 56 as described above. This allows flexibility to allow for spot coating of these coatings, or to use various combinations of purchased materials and coatings.

### Example A

To manufacture the four-part form 51 illustrated in FIGS. 2-8, in which the top part 53 is an instruction sheet, the second 54 is a part on which someone writes information using a pen, and that information is expected to transfer to bottom parts 55 and 56, a roll CB paper may be used for the web 11. CF coating is selectively applied to parts 55 and 56, but not in the areas 59, 60 reserved for the barcode or other variable data. The four-part form 51 can be manufactured in one pass though the system 10, including adhesive binding in the stub areas 70 and adhesive coated liner application on the bottom of part 56.

Suitable substrates include CB coated carbonless paper for all four parts of the form 51. Silicone liner 27 and hot melt adhesive may be used for the label section on the bottom of part 56. The method may be carried in the following order: The roll of paper is unwound from a butt splicer 14 and webbed through flexographic print-heads 16-19. Static (non-variable) printed elements such as copy, color graphics, CF coating, and/or CB coatings may be printed on the front or back of the paper at any of these print-heads 16-19. As opposed to flexographic print-heads, digital print-heads may be employed.

Flexographic printing requires mounting a flexible plate on a print cylinder, which is installed in the print stations 16-19 and used to apply ink to the web 11. The images on the plate print repeatedly as the cylinder rotates in the press. The diameter of the cylinder varies, depending on the length of the print. Generally, the printed copy appears multiple times around one cylinder. When printing a multipart form flexographically, a single plate comprises all of the copy for all of the parts. Generally the copy for each part occupies a single position on the plate, and thus the cylinder. Each part is positioned on the plate in the order that it will appear in the finished multipart form. Accordingly, for the four-part form 51, there are four images on the plate as shown in FIG. 2. At the end of the manufacturing process, the printed web of material is cut into individual sheets at the cutter 35. Each of the four parts 53-56 are cut into individual sheets. The sheets are stacked so that the parts 53-56 are in the proper order at the sheeter 38 when they are bound together in the star-wheel stacker 41.

When there are multiple colors or coatings on any part, additional plates and print cylinders may be installed in print stations 16-19 or 20, with the copy for the individual parts positioned the same way as described above.

Using digital imaging, the print cylinders and plates can be eliminated and all of the printing can be accomplished using the ink jet printers 21, 22 or other digital printing technology. Digital imaging will be useful when there are a higher number of parts per multipart form, where the diameter of the print cylinder would have to be larger than would fit into a flexographic print-head. Digital printing technology also adds the ability to print almost limitless combinations of variable printing that may be preferred in multi-part forms.

Returning to FIG. 1, after printing the static information flexographically on the web 11, the web 11 is passed through the computerized variable printer(s) 21, 22 and variable data, such as sequential numbers and barcodes, is printed on the web 11 of material. The web 11 is then passed through flexographic print-head 20, and a varnish, additional static printed elements, another color, CF or CB coating may be printed on the web. The web 11 then travels through rotary die station(s) 24, where the web 11 can be die cut to create perforations (see 62 in FIG. 2), label cavities, slits, or any other specified die cutting on the web of material. Optionally, the web 11 proceeds to the integrated label patch applicator 26, where silicone liner 27 is webbed through a hot melt adhesive applicator 31, where hot melt adhesive is coated on the liner 27. The adhesive coated liner patch 127 (FIG. 8) can be any length desired at the cutter 32 to provide adhesive and backing liner to a label area on at least one part of the form 51. The length is determined by entering a number in the computer controller of the integrated label patch applicator. The silicone liner web 27 is fed by feed rollers 34 to the vacuum cylinder 33 that rotates with the web direction. The vacuum cylinder 33 holds the liner web 27 in place while a cutting cylinder 32 cuts the liner 127 from the web 27. A silicone application roller is used on the knives of the cutting cylinder to prevent the exposed hot melt adhesive from sticking to the knives. If the liner is pre-printed, a sensor may be used to read the print position. The integrated label patch applicator module is programmed to time the cut position of the cut cylinder 32 to the print position so that the print is in registry as the liner 127 is cut from liner web 27. The vacuum cylinder 33 carries each cut-off liner patch 127 (FIG. 8) around to an impression roller 100 (see FIG. 1) that is wrapped by the main web 11 and at the impression roller the adhesive coated liner 127 is transferred from the vacuum cylinder to the back of the web 11 to the position shown at 127 in FIG. 8. As it transfers off of the vacuum cylinder, the liner 127 is adhered to the web 11 by the hot melt adhesive that was applied earlier at 31. Through this process, a pressure sensitive label is manufactured on part of the form 51. The adhesive that was coated on the liner 127 will transfer off of the liner 127 and onto the bottom of the part 56. That is, the liner 127 is peeled from the bottom part 56, the adhesive will stay with the part 56 and the liner 127 will be substantially free of adhesive.

After exiting the integrated label patch applicator 26, the web 11, which now includes an integrated label on the bottom part 56, can pass through the rotary die cutting section 35 where additional die cutting and trim slitting is performed. Waste removal is performed at 36. Next, the web 11 passes under an adhesive applicator 37, which is controlled by a computerized timer, and which is programmed to apply a patterned length of adhesive on top of stub portions 70 of the web 11, excluding the stub 70 of the cover sheet 53. In the course of sheeting at 38 and stacking at 41, a consecutive page will automatically be adhered atop each page that had adhesive applied. Since the cover part 53 is not coated, a breaking point between multi-part forms 51 is created. If the parts 53-56 are printed flexographically, the length of the pattern of adhesive is coordinated with the number of parts printed by the plate. The position of this adhesive application is adjustable by digital settings in the computerized timer that controls the adhesive applicator. The starting point of the adhesive pattern is triggered either by a sensor that reads a printed mark on the web or by the digital printer, or by an output signal sent directly from the controller of the digital printer to the timer for the adhesive applicator 37. The adhesive applicator 37 can be programmed to turn the adhesive on and off at the top and bottom margin of each part so that when the web 11 is sheeted, the adhesive will not contact the blades of the sheeter 38. This procedure will prevent jams in the sheeter 38 that could be caused by the adhesive sticking to the sheeter blades.

After the forms are then sheeted at the sheeter station 38, the sheeted forms are fed into a star-wheel stacker 41, which stacks the sheets one at a time on their edge. As they are stacked, the adhesive that was coated on the top stub 70 causes all sheets in each multi-part form to be bound together.

While only certain embodiments have been set forth, alternatives and modifications will be apparent from the above description to those skilled in the art. These and other alternatives are considered equivalents and within the spirit and scope of this disclosure and the appended claims.

1. A method for manufacturing a multi-part form (MPF) comprising:
passing a single web through at least one print-head wherein the at least one print-head prints different parts of the MPF on different portions of the web, the at least one print-head printing copy on one or more of the parts, the copy printed on the parts by the at least one print-head including indicia for an ordered sequence of parts of the MPF, one of the parts being a cover sheet;
cutting the parts;
selectively coating stub areas of the parts other than the cover sheet with adhesive; and
stacking the parts in the ordered sequence so that the coated stub areas are in matching registry with one another and the cover sheet is stacked on top.

2. The method of claim 1 wherein the parts of the MPF are stacked in a star-wheel stacker.

3. The method of claim 1 further comprising printing variable data on at least some of the parts, the variable data selected from the group consisting of a serial number, a tracking number and a barcode.

4. The method of claim 3 wherein variable data is printed on each part.

5. The method of claim 1 wherein a single print-head is used to print the MPF.

6. The method of claim 1 further comprising:
passing the web through at least one additional print-head for printing a CF coating on the top surface of one or more parts.

7. The method of claim 1 wherein a bottom side of the web is coated with a CB coating.

8. The method of claim 1 wherein a flexographic printer is used to coat a bottom side of the web with a CB coating.

9. The method of claim 1 wherein at least one part comprises an integrated label.

10. An MPF made in accordance with claim 1.

11. A method for manufacturing a multi-part form (MPF) in an ordered sequence, the plurality of parts including a cover sheet, the method comprising:
passing a single web having a bottom side coated with CB coating through at least one print-head and printing copy on one or more of the parts with the at least one print-head, the copy printed on the parts by the print-head including indicia for the ordered sequence of parts of the MPF;
passing the web through a digital printer for the printing of variable data on at least some of the parts;
passing the web through at least one additional print-head for printing a CF coating on a top surface of one or more parts;
cutting the parts;
selectively coating stub areas of the parts other than the cover sheet with adhesive; and
stacking the parts in the ordered sequence so that the coated stub areas are in matching registry with one another and the cover sheet is stacked on top.

12. The method of claim 11 wherein the parts of the MPF are stacked in a star-wheel stacker.

13. The method of claim 11 wherein at least one part includes an integrated label.

14. An MPF made in accordance with claim 11.

15. The method of claim 11 wherein the variable data is selected from the group consisting of a serial number, a tracking number and a barcode.

16. The method of claim 15 wherein variable data is printed on each part.

17. The method of claim 11 wherein a single print-head is used to print the copy of the MPF.

18. A method for manufacturing a multi-part form (MPF) including a plurality of parts including a cover sheet, the method comprising:
passing a single web having a bottom side coated with a CB coating through at least one print-head for printing different parts of the MPF on different portions of the web, the at least one print-head printing copy on one or more of the parts, the copy printed on the parts by the at least one print-head including indicia for an ordered sequence of parts of the MPF;
passing the web through a digital printer for the printing of variable data on at least some of the parts;
passing the web through at least one additional print-head for printing a CF coating on the top surface of one or more parts;
cutting the parts;
selectively coating stub areas of the parts other than the cover sheet with adhesive; and
stacking the parts in the ordered sequence so that the coated stub areas are in matching registry with one another and the cover sheet is stacked on top.

19. The method of claim 18 wherein a single print-head is used to print the copy of the MPF.

20. The method of claim 19 wherein at least one part includes an integrated label.
